(19) United States
(12) Patent Application Publication
(10) Pub. No.: US 2023/0119014 A1
(43) Pub. Date: Apr. 20, 2023

(54) ELECTRODE ASSEMBLY OF SECONDARY BATTERY, AND SECONDARY BATTERY

(71) Applicant: Xiamen Hithium Energy Storage Technology Co., Ltd., Xiamen (CN)

(72) Inventors: Yang TANG, Xiamen (CN); Nan ZHANG, Xiamen (CN); Weidong XU, Xiamen (CN); Ziqi YI, Xiamen (CN); Zuyu WU, Xiamen (CN)

(73) Assignee: Xiamen Hithium Energy Storage Technology Co., Ltd., Xiamen (CN)

(21) Appl. No.: 17/963,529

(22) Filed: Oct. 11, 2022

(30) Foreign Application Priority Data
Oct. 19, 2021 (CN) 202122518106.9

(51) Int. Cl. H01M 10/0587

(52) U.S. Cl. CPC H01M 10/0587

(57) ABSTRACT

An electrode assembly of a secondary battery and a secondary battery are provided. The assembly has a positive electrode sheet, a separator and a negative electrode sheet. The positive electrode sheet has a positive electrode main body area and a positive pole tab area. A side of the positive electrode main body area is coated with a positive pole active material layer. The negative electrode sheet has a negative pole main body area and a negative pole tab area. A side of the negative pole main body area is coated with a negative pole active material layer. The separator is sandwiched between the positive pole active material layer and the negative pole active material layer.

### FIELD

The present application relates to the field of battery technology, and in particular, to an electrode assembly of a secondary battery and a secondary battery.

### BACKGROUND

Batteries, such as secondary batteries, have the advantages of high energy density, high power density, many cycles, and long storage time, and are widely used. The battery is mainly composed of a casing, an electrode assembly housed inside the casing, and a top cover covering the opening of the casing. The battery core is formed by stacking and winding the positive electrode sheet, the separator and the negative electrode sheet in sequence, and the battery core has a first side and a second side opposite to each other. The first side and the second side correspond to the two opposite sides of the positive electrode sheet along the length direction.

During the charging process of the electrode assembly, there is a risk of short circuit between the first side and the second side of the electrode assembly, thereby affecting the safety of the battery.

### SUMMARY

In view of the above deficiencies, the present application provides a secondary electrode assembly and a secondary battery, which can improve the safety of using the battery.

In order to solve at least the above technical problems, in the first aspect, the present application provides an electrode assembly of a secondary battery.

The electrode assembly includes a positive electrode sheet, a separator and a negative electrode sheet that are stacked in sequence and wound. The positive electrode sheet includes a positive electrode main body area and a positive pole tab area, and at least one side of the positive electrode main body area is coated with a positive pole active material layer.

The negative electrode sheet includes a negative pole main body area and a negative pole tab area, at least one side of the negative pole main body area is coated with a negative pole active material layer, and the separator is sandwiched between the positive pole active material layer and the negative pole active material layer.

Along a width direction of the electrode assembly of the secondary battery, edges on both sides of the separator extend beyond edges on both sides of the negative pole main body area, and edges on both sides of the negative pole main body area extend beyond edges on both sides of the positive electrode main body area.

In the present application, along the width direction of the battery core of the secondary battery, the edges on both sides of the separator extend beyond the edges on both sides of the negative pole main body area, the edges on both sides of the negative pole main body area extend beyond the edges on both sides of the positive electrode main body area, and at least one side of the negative pole main body area is coated with the negative pole active material layer. Therefore, the width of the positive pole active material layer is smaller than the width of the negative pole active material layer, and the width of the separator is smaller than the width of the negative pole active material layer. When the separator is sandwiched between the positive pole active material layer and the negative pole active material layer, the positive pole active material layer and the negative pole active material layer can be completely insulated from each other, thereby avoiding the occurrence of short circuits between the negative electrode sheet and the positive electrode sheet. In addition, since the edges on both sides of the negative pole main body area extend beyond the edges on both sides of the positive electrode main body area, the lithium ions detached from the positive pole active material layer can be smoothly embedded into the negative pole active material layer, thereby avoiding the occurrence of lithium precipitation on the negative electrode sheet, so as to avoid the safety accidents caused by the puncture of the separator, and improve the safety of the electrodes assembly of the secondary battery.

The positive electrode main body area has a first positive pole side edge area and a second positive pole side edge area opposite to each other.

The separator has a first separator side edge area and a second separator side edge area opposite to each other.

The negative pole main body area has a first negative pole side edge area and a second negative pole side edge area opposite to each other.

Along a width direction of the electrode assembly of the secondary battery, a length distance by which an edge of the first separator side edge area extends beyond an edge of the first negative pole side edge area is D1, and a length distance by which an edge of the second separator side edge area extends beyond an edge of the second negative pole side edge area is D2, wherein D1=D2.

A length distance by which an edge of the first negative pole side edge area extends beyond an edge of the first positive pole side edge area is D3, and a length distance by which an edge of the second negative pole side edge area extends beyond an edge of the second positive pole side edge area is D4, wherein D3=D4.

In the present application, since the width D1 of the first separator side edge area beyond the first negative pole side edge area is equal to the width D2 of the second separator side edge area beyond the second negative pole side edge area, it can be known that the part of the first separator side edge area beyond the second negative pole side edge area and the part of the second separator side edge area beyond the second negative pole side edge area are symmetrical with respect to the center line of the negative electrode sheet in the width direction. And because the width D3 of the first negative pole side edge area beyond the first positive pole side edge area is equal to the width D4 of the second negative pole side edge area beyond the second positive pole side edge area, it can be known that the part of the first negative pole side edge area beyond the first positive pole side edge area and the part of the second negative pole side edge area beyond the second positive pole side edge area is symmetrical with respect to the center line of the negative electrode sheet along the width direction. In this way, the negative electrode sheet and the positive electrode sheet can be completely insulated from each other, thereby avoiding a short circuit between the negative electrode sheet and the positive electrode sheet. In addition, because the width D3 of the first negative pole side edge area beyond the first positive pole side edge area is equal to the width D4 of the second negative pole side edge area beyond the second positive pole side edge area, the edge of the first negative pole side edge area can also be avoided. In addition, because the width D3 of the first negative pole side edge area beyond the first positive pole side edge area is equal to the width D4 of the second negative pole side edge area beyond the second positive pole side edge area, it can also avoid the occurrence of lithium precipitation at the edges of the first negative pole side edge area and the edges of the second negative pole side edge area, thereby ensuring the safety of the electrode assembly.

In a possible implementation manner of the first aspect, the positive electrode main body area includes a positive-pole-active-material-coated area and an insulating-material-coated area, the insulating-material-coated area is located between the positive-pole-active-material-coated area and the positive pole tab area, and the positive pole active material layer is coated on the positive-pole-active-material-coated area.

The surface of the positive pole tab area includes a positive pole tab root area and a positive pole tab end area, the insulating-material-coated area and the positive pole tab root area are both coated with an insulating layer, and a width of the positive pole tab root area is greater than a width of the insulating-material-coated area along a width direction of the electrode assembly of the secondary battery, and an edge of the positive pole active material layer on the positive electrode main body area overlaps an edge of the insulating layer.

Since a large number of burrs will be generated on the positive electrode sheet during the process of forming tabs by die cutting, there is a risk of puncturing the separator and causing a short circuit. Therefore, by coating insulating layers on both the insulating-material-coated area and the positive pole tab root area, it is possible that during the die-cutting process of the tabs, the burrs generated by the positive electrode sheet are prevented from piercing the separator to make the positive electrode sheet and the negative electrode sheet directly contacted and short-circuited, thereby greatly improving the safety and reliability of the battery.

In a possible implementation manner of the first aspect, along the width direction of the electrode assembly of the secondary battery, a width of the insulating-material-coated area is S1, wherein value of S1:D1 or S1:D2 is 0.6˜0.7, and value of S1:D3 or S1:D4 is 2˜3.

In this way, not only the insulation between the positive electrode sheet and the negative electrode sheet can be ensured, the short circuit between the positive electrode sheet and the negative electrode sheet can be avoided, the safety of the battery can be improved, but also the waste of the separator material can be avoided, saving the production cost of the electrode assembly.

In a possible implementation manner of the first aspect, value of S1:D1 or S1:D2 is 0.615, and value of S1:D3 or S1:D4 is 1.6.

Therefore, on the premise of ensuring the insulation between the positive electrode sheet and the negative electrode sheet, the safety of using and operating the electrode assembly is improved, and the production cost of the electrode assembly is reduced.

In a possible implementation manner of the first aspect, a length of the electrode assembly of the secondary battery is A, wherein 168 mm≤A≤172 mm, and thickness of the electrode assembly of the secondary battery is B, wherein 30 mm≤B≤33 mm; and

both D1 and D2 are 3 mm˜4 mm, and both D3 and D4 are 1 mm˜2 mm.

In this way, the lithium ions detached from the positive pole active material layer can be smoothly embedded into the negative pole active material layer when the battery is charged, which reduces the occurrence of lithium precipitation, and improves the safety of using and operating the battery, and at the same time avoids the material waste of the negative electrode sheet. As a result, the production cost of the battery can be reduced.

In a possible implementation manner of the first aspect, a width of the insulating-material-coated area is greater than or equal to 1.5 mm, and smaller than or equal to 2.5 mm, along a width direction of the electrode assembly of the secondary battery. Therefore, on the premise of ensuring that the burr portion of the positive electrode sheet is completely covered, the energy density of the electrode assembly can also be guaranteed.

In a possible implementation manner of the first aspect, the negative pole tab area includes a negative pole tab root area and a negative pole tab end area, and the negative pole tab root area is coated with the negative pole active material layer.

Thereby, the strength of the negative pole tab root area can be improved, at the negative pole tab root area.

In a possible implementation manner of the first aspect, along a direction of the negative pole main body area pointing to the negative pole tab area, an edge of the negative pole active material layer on the negative electrode sheet extends beyond an edge of the insulating layer on the positive electrode main body area.

In this way, the lithium ions detached from the positive pole active material layer can be smoothly embedded into the negative pole active material layer, thereby effectively reducing the occurrence of lithium precipitation.

In the second aspect, the present application also provides a battery.

The battery includes: a casing, which is provided with an opening at one side thereof and an accommodating cavity therein; the electrode assembly of the secondary battery according to the first aspect, wherein the electrode assembly of the secondary battery is located in the accommodating cavity; and a top cover, which sealingly covers the opening.

The secondary battery provided by the present application adopts the electrode assembly of the secondary battery in the first aspect, and the electrode assembly of the secondary battery can make the negative electrode sheet completely isolated from the positive electrode sheet, thereby preventing a short circuit between the negative electrode sheet and the positive electrode sheet. As a result, the safety of the secondary battery during operation can be further improved.

### BRIEF DESCRIPTION OF DRAWINGS

In order to illustrate the technical solutions in the embodiments of the present application more clearly, the drawings used in the embodiments will be briefly introduced below. Obviously, the drawings in the following description show only some embodiments of the present application. For those skilled in the art, other drawings can also be obtained based on these drawings without any creative efforts.

FIG. 1 is a schematic structural diagram of an electrode assembly in an unfolded state provided by an embodiment of the present application;

FIG. 2 is a schematic structural diagram of an anode electrode sheet provided by an embodiment of the present application;

FIG. 3 is a schematic structural diagram of a negative electrode sheet provided by an embodiment of the present application;

FIG. 4 is the partial enlarged schematic diagram at F in FIG. 2;

FIG. 5 is a schematic structural diagram of a battery core in a wound state according to an embodiment of the present application;

FIG. 6 is the partial enlarged schematic diagram at Y in FIG. 5;

FIG. 7 is the partial enlarged schematic diagram at X in FIG. 4;

FIG. 8 is the partial enlarged schematic diagram at E in FIG. 2; and

FIG. 9 is a schematic structural diagram of a battery provided by an embodiment of the present application.

### DESCRIPTION OF REFERENCE NUMBERS

10—Secondary battery;

100—electrode assembly of secondary battery; 111—positive electrode sheet; 111x—positive electrode main body area; 111y—positive pole tab area; 111y1—positive pole tab root area; 111y2—positive pole tab end area; 111a1—positive pole coating area; 111a2—insulating-material-coated area; 111b—positive pole active material layer; 111c—insulating layer; 1111—first positive pole side edge area; 1112—second positive pole side edge area; 112—separator; 112a—first separator; 112b—second separator; 1121—the first separator side edge area; 1122—the second separator side edge area; 113—negative electrode sheet; 113b—negative active material layer; 113x—negative pole main body area; 113y—negative pole tab area; 113y1—negative pole tab root area; 113y2—negative pole tab end area; 1131—first negative pole side edge area; 1132—second negative pole side edge area;

200—casing; 210—opening; and 220—accommodating cavity.

### DESCRIPTION OF EMBODIMENTS

The technical solutions of the present disclosure will be further described below in details through embodiments and in conjunction with the drawings. The same or similar reference signs indicate the same or similar components throughout the description. The following description of embodiments of the present disclosure with reference to the drawings is intended to explain the general inventive concept of the present disclosure, and should not be construed as a limitation to the present disclosure.

The technical solutions in the embodiments of the present application will be clearly and completely described below with reference to the drawings in the embodiments of the present application. Obviously, the described embodiments are only a part of the embodiments of the present application, rather than all of the embodiments. Based on these embodiments of the present application, all other embodiments, which are obtained by those skilled in the art without creative work, fall within the protection scope of the present application.

In the present application, the orientation or positional relationship, indicated by the terms, “upper”, “lower”, “left”, “right”, “front”, “rear”, “top”, “bottom”, “inner”, “outer”, “vertical”, “horizontal”, “crosswise”, “longitudinal”, etc., is based on the orientation or positional relationship shown in the drawings. These terms are primarily intended to better describe the present application and the embodiments thereof, and not to stipulate that the indicated device, element or component must be in the particular orientation, or be constructed and operated in the particular orientation.

In addition, some of the above-mentioned terms may be used to express other meanings besides orientation or positional relationship. For example, the term “on” may also be used to express a certain attachment or connection relationship in some cases. For those skilled in the art, the specific meanings of these terms in the present application can be understood according to specific situations.

Furthermore, the terms, “installed”, “arranged”, “provided”, “connected”, “connected with each other” should be construed broadly. For example, it may be a fixed connection, a detachable connection, or a unitary structure; it may be a mechanical connection, or an electrical connection; it may be directly connected, or indirectly connected through an intermediary, or internally communicated between two devices, elements, or components. For those skilled in the art, the specific meanings of the above terms in the present application can be understood according to specific situations.

In addition, the terms, “first”, “second”, etc., are mainly used to distinguish different devices, elements or components (the specific types and structures may be the same or different), and not to indicate or imply the importance of relativity and the number of the indicated devices, elements or components, etc. Unless stated otherwise, “plurality” means two or more.

The battery comprises a casing, which is provided with an opening on one side and is hollow inside; an electrode assembly; and a top cover assembly. The electrode assembly is accommodated in the casing, and the top cover assembly is used to cover the opening of the casing, so that the electrode assembly is installed in the casing. The top cover assembly comprises an upper plastic, a cover body, a lower plastic and a pole column. The lower plastic is arranged on the lower surface of the cover body, for making the electrode assembly and the cover body assembled fixedly, and the upper plastic is fixed on the upper surface of the cover body. One end of the pole column is fixed with the lower plastic and is electrically connected with the battery core, and the other end of the pole column is fixed on the cover body, by passing through the cover body and the upper plastic in sequence.

The electrode assembly comprises a positive electrode sheet, a separator and a negative electrode sheet, and the separator is located between the positive electrode sheet and the negative electrode sheet and spaced from them. There are two structures, in each of which the positive electrode sheet, the separator and the negative electrode sheet form the electrode assembly. In one possible structure, the negative electrode sheet, the separator and the positive electrode sheet are stacked in sequence and wound to form the electrode unit of the electrode assembly, that is, the electrode unit is of a wound structure. In another possible structure, the negative electrode sheet, the separator and the positive electrode sheet are stacked in sequence to form an electrode unit of the electrode assembly, and the electrode unit is of a laminated structure. In addition, the formed electrode unit has a gap, and the electrolyte can enter the electrode unit through the gap and infiltrate the negative electrode sheet and the positive electrode sheet.

The negative electrode sheet comprises a negative pole current collector (such as, copper foil) and a negative pole active material layer (such as, carbon or silicon) coated on the surface of the negative pole current collector. The positive electrode sheet comprises a positive electrode main body area (such as, aluminum foil) and the positive pole active material layer (e.g., ternary material, lithium iron phosphate or lithium cobalt oxide) coated on the surface of the positive electrode main body area. The negative pole tab is connected to the negative electrode sheet and protrudes from the electrode unit, and the negative pole tab can be directly formed by cutting the negative pole current collector. The positive pole tab is connected to the positive electrode sheet and protrudes from the electrode unit. The positive pole tabs can be directly formed by cutting the positive electrode main body area.

In addition, the electrode assembly has first and second sides opposite to each other. The first and second sides correspond to two opposite side edges of the positive electrode sheet extending along the winding direction or the stacking direction. During the charging process of the electrode assembly, there is a risk of short circuit between the first side edge and the second side edge of the electrode assembly, thereby affecting the safety of using and operating the electrode assembly.

In view of this point, the embodiments of the present application provide an electrode assembly of a secondary battery and a secondary battery, which can improve the safety of using and operating the battery.

The electrode assembly of the secondary battery and the secondary battery are described in detail below through specific embodiments:

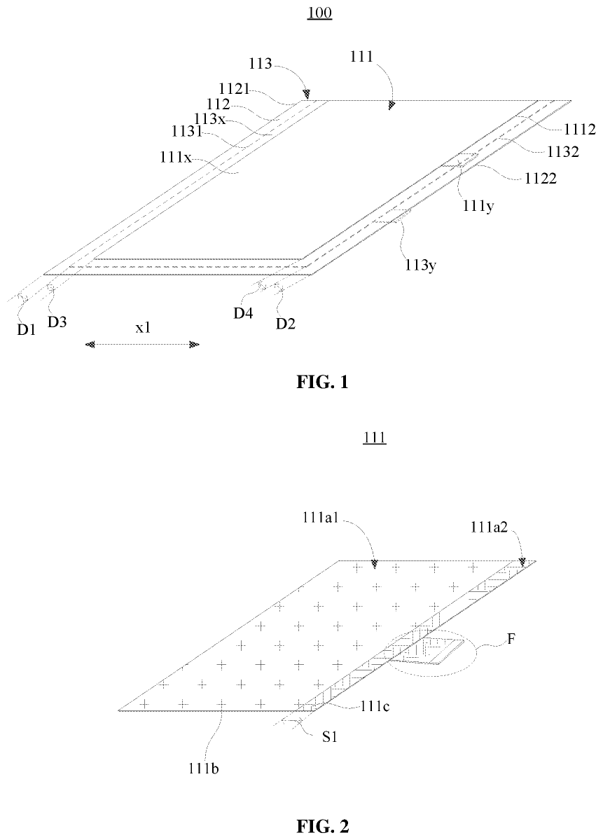

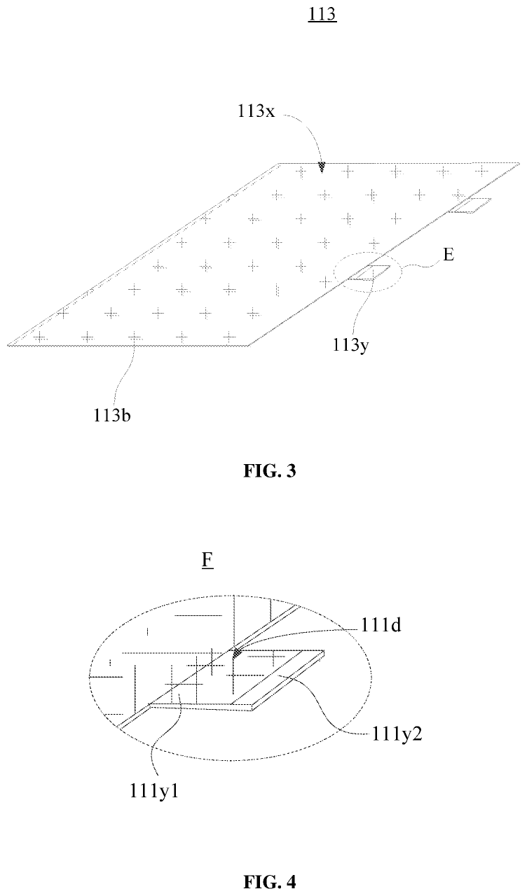

The embodiment of the present application provides an electrode assembly 100 of a secondary battery. The electrode assembly 100 of the secondary battery comprises an electrode assembly 110 of a secondary battery. As shown in FIG. 1, the positive electrode sheet 111, the separator 112 and the negative electrode sheet 113 are stacked in sequence and wound. As shown in FIG. 2, at least one side of the positive electrode main body area 111x is coated with a positive pole active material layer 111b. With reference to FIG. 3, the negative electrode sheet 113 comprises a negative pole main body area 113y and a negative pole tab area 113y. At least one side of the negative pole main body area 113y is coated with a negative pole active material layer 113b, and the separator 112 is sandwiched between the positive pole active material layer 111b and the negative pole active material layer 113b. Along the width direction of the electrode assembly 100 of the secondary battery, the edges on both sides of the separator 112 extend beyond edges on both sides of the negative pole main body area 113y. The edges on both sides of the negative pole main body area 113y extend beyond the edges on both sides of the positive electrode main body area 111x.

In an embodiment, along the width direction of the electrode assembly 100 of the secondary battery, the edges on both sides of the separator 112 extend beyond the edges on both sides of the negative pole main body area 113y, and the edges on both sides of the negative pole main body area 113y extend beyond the edges on both sides of the positive electrode main body area 111x, and at least one side of the negative pole main body area 113y is coated with the negative pole active material layer 113b, and at least one side of the positive electrode main body area is coated with the positive pole active material layer 111b. Therefore, the width of the positive pole active material layer 111b is smaller than the width of the negative pole active material layer 113b. When the separator 112 is sandwiched between the positive pole active material layer 111b and the negative pole active material layer 113b, the positive pole active material layer 111b and the negative pole active material layer 113b can be completely insulated from each other, thereby avoiding the situation of a short circuit between the negative electrode sheet 113 and the positive electrode sheet 111.

In addition, if the edges on both sides of the negative pole main body area 113x do not extend beyond the edges on both sides of the positive electrode main body area 111x. That is, the width of the negative pole active material layer 113b is smaller than the width of the positive pole active material layer 111b. In this case, when the electrode assembly 100 of the secondary battery is charged, part of the lithium ions precipitated from the positive pole active material layer 111b won't be smoothly embedded into the negative pole active material layer 113b, and this part of the lithium ions will be precipitated on the edge surfaces on both sides of the negative pole main body area. In other words, the phenomenon of lithium precipitation occurs, and the lithium precipitation will cause the capacity of the electrode assembly 100 of the secondary battery to decay rapidly, and the lithium dendrites formed by the lithium precipitation can easily pierce the separator 112, which causes the internal short circuit of the electrode assembly 100 of the secondary battery and a safety accident happens. Based on this, in this embodiment, the edges on both sides of the negative pole main body area 113x are made to extend beyond the edges on both sides of the positive electrode main body area 111x, thus ensuring the safety of the electrode assembly 100 of the secondary battery.

It should be noted that the current collector material of the positive electrode sheet 111 may be aluminum. The current collector material of the negative electrode sheet 113 may be copper. The material of the separator 112 may be PP (polypropylene)/PE (polyethylene)/composite material or the like. The material of the positive pole active material layer 111b may be mixture of a positive pole material, a binder (PVDF (polyvinylidene fluoride)), a conductive agent (conductive carbon black, acetylene black, CNT (carbon nanotube), VC/GF (glass fiber)/CG (carbon fiber)), solvent (NMP (1-methyl 2-pyrrolidone)/water), etc. The positive pole material can be lithium iron phosphate, lithium cobalt oxide, ternary material (nickel cobalt manganese/nickel cobalt aluminum), lithium manganate, etc. The negative pole active material layer 113b can be mixture of a negative pole material, a binder (CMC+SBR), a conductive agent (conductive carbon black, acetylene black, CNT (carbon nanotube), VC/GF (glass fiber)/CG (carbon fiber)), solvents (water), etc. The negative pole material can be a mixture of graphite, lithium titanate, silicon, and the like.

As shown in FIG. 1, the positive electrode sheet 111 comprises a positive electrode main body area 111x and a positive pole tab area. The positive electrode main body area 111x has a first positive pole side edge area 1111 and a second positive pole side edge area 1112 opposite to each other, and the separator 112 has a first separator side edge area 1121 and a second separator side edge area 1122 opposite to each other. The negative electrode sheet comprises a negative pole main body area 113x and a negative pole tab area 113y, and the negative pole main body area 113x has a first negative pole side edge area 1131 and a second negative pole side edge area 1132 opposite to each other. The width of the first separator side edge area 1121 beyond the first negative pole side edge area 1131 is D1, the width of the second separator side edge area 1122 beyond the second negative pole side edge area 1132 is D2, and D1=D2. The width of the first negative pole side edge area 1131 beyond the first positive pole side edge area 1111 is D3, the width of the second negative pole side edge area 1132 beyond the second positive pole side edge area 1112 is D4, and D3=D4.

Since the width D1 of the first separator side edge area 1121 beyond the first negative pole side edge area 1131 is equal to the width D2 of the second separator side edge area 1122 beyond the second negative pole side edge area 1132, it can be known that the part of the first separator side edge area 1121 beyond the first negative pole side edge area 1131 and the part of the second separator side edge area 1122 beyond the second negative pole side edge area 1132 are symmetrical with respect to the center line of the negative electrode sheet 113 in the width direction. Because the width D3 of the first negative pole side edge area 1131 beyond the first positive pole side edge area 1111 is equal to the width D4 of the second negative pole side edge area 1132 beyond the second positive pole side edge area 1112, it can be known that the part of the first negative pole side edge area 1131 beyond the first positive pole side edge area 1111 and the part of the second negative pole side edge area 1132 beyond the second positive pole side edge area 1112 is symmetrical with respect to the center line of the negative electrode sheet 113 in the width direction. In this way, the negative electrode sheet 113 and the positive electrode sheet 111 can be completely insulated from each other, thereby preventing a short circuit between the negative electrode sheet 113 and the positive electrode sheet 111 from occurring. The width D3 of the first negative pole side edge area 1131 beyond the first positive pole side edge area 1111 is equal to the width D4 of the second negative pole side edge area 1132 beyond the second positive pole side edge area 1112, which can also prevent lithium precipitation from occurring at the edges of the first negative pole side edge area 1131 and the second negative pole side edge area 1132, thereby ensuring the safety of the electrode assembly 100 of the secondary battery.

It should be noted that the sizes of D1 and D2 are not limited, and the sizes of D3 and D4 are not limited. For example, D1=D2=3 mm, D3=D4=2 mm, as long as the positive electrode sheet 111 and the negative electrode sheet 113 can be isolated from each other, and at the same time, it should be sufficient to avoid lithium precipitation at the edge of the first negative pole side edge area 1131 and the edge of the second negative pole side edge area 1132.

It should also be noted that the width direction of the electrode assembly of the secondary battery mentioned above refers to the direction indicated by the arrow xl in FIG. 1.

In some embodiments, as shown in FIGS. 2 and 4, the surface of the positive electrode main body area 111x comprises a positive-pole-active-material-coated area 111a1 and an insulating-material-coated area 111a2, and the insulating-material-coated area 111a2 is located between the positive-pole-active-material-coated area 111a1 and the positive pole tab area. The positive pole active material layer 111b is coated on the positive-pole-active-material-coated area 111a1. The surface of the positive pole tab area 111y comprises the positive pole tab root area 111y1 and the positive pole tab root area 111y2. The insulating-material-coated area 111a2 and the positive pole tab root area 111y2 are both coated with an insulating layer 111c. Along the width direction of the electrode assembly 100 of the secondary battery, the width of the positive pole tab root area 111y2 is larger than the width of the insulating-material-coated area 111a2, and the edge of the positive pole active material layer 111b on the positive electrode main body area 111x overlaps the edge of the insulating layer 111c.

Thus, by coating the positive pole active material layer 111b on the positive-pole-active-material-coated area 111a1, the conductivity of the positive electrode sheet can be improved, thereby improving the charging rate of the electrode assembly of the secondary battery.

In addition, since a large number of burrs will be generated in the insulating-material-coated area 111a2 and the positive pole tab root area 111y1 during the process of forming the tabs by die-cutting, there is a risk of piercing the separator 112 to cause a short circuit. Thus, by coating the insulating layer 111c on the insulating-material-coated area 111a2 and the positive pole tab root area 111y2, during the die-cutting process of the tabs, the following can be prevented: the burrs generated at the insulating-material-coated area 111a2 and the positive pole tab root area 111y1 piercing the separator 112 to cause the positive electrode sheet 111 and the negative electrode sheet 113 to be directly contacted and short-circuited. Thus, the safety and reliability of the electrode assembly 100 of the secondary battery can be significantly improved. In addition, by coating the insulating layer 111c on the insulating-material-coated area 111a2, the lithium precipitation on the negative electrode sheet 113 can also be avoided.

For example, along the width direction of the battery 10 of the secondary battery, the total width of the insulating layer 111c is 10 mm. The width of the insulating layer 111c on the positive electrode main body area 111x is 2 mm, and the width of the insulating layer 111c on the positive pole tab root area 111y1 is 8 mm. The edge of the insulating layer 111c located on the positive electrode main body area 111x and the edge of the positive pole active material layer 111b on the positive electrode main body area 111x have an overlap area with the width of at least 0.5 mm, which ensures the connection between the edge of the insulating layer 111c and the edge of the positive pole active material layer 111b. In other words, the insulating layer 111c and the positive pole active material layer 111b completely cover the positive electrode main body area 111x. Thus, on the premise of ensuring the charging effect of the electrode assembly 100 of the secondary battery, the following can be avoided: the burrs generated in the insulating-material-coated area 111a2 and the positive pole tab root area 111y1 piercing through the separator 112 to cause a short circuit inside the electrode assembly 100 of the secondary battery. As a result, the safety of the electrode assembly 100 of the secondary battery can be ensured.

In some embodiments, along the width direction of the electrode assembly 100 of the secondary battery, the width of the insulating-material-coated area 111a2 is S1, the ratio of S1:D1 or S1:D2 is 0.6-0.7, and the ratio of S1:D3 or S1:D4 is 2˜3.

For example, the ratio of S1:D1 or S1:D2 is 0.6, 0.61, 0.62, 0.63, 0.64, 0.65, 0.66, 0.67, 0.68, 0.69, 0.7, etc., and the ratio of S1:D3 or S1:D4 is 2, 2.1, 2.2, 2.3, 2.4, 2.5, 2.6, 2.7, 2.8, 2.9, 3, etc.

When the ratio of S1:D1 or S1:D2 and the ratio of S1:D3 or S1:D4 are both relatively large, the width of the first separator side edge area 1121 of the separator 112 beyond the first negative pole side edge area 1131 and the width of the second separator side edge area 1122 of the separator 112 beyond the second negative pole side edge area 1132 are both relatively small. At this time, it is difficult to ensure that the positive electrode sheet 111 and the negative electrode sheet 113 are insulated from each other. When the ratio of S1:D1 or S1:D2 and the ratio of S1:D3 or S1:D4 are both relatively small, the width of the first negative pole side edge area 1131 beyond the first positive pole side edge area 1111 and the width of the second negative pole side edge area 1132 beyond the second positive pole side edge area 1112 are both relatively large, thereby causing great waste of the separator 112 and increasing the production cost of the electrode assembly 100 of the secondary battery.

Therefore, as overall considerations, when the ratio of S1:D1 or S1:D2 is 0.6˜0.7, and the ratio of S1:D3 or S1:D4 is 2˜3, the insulation between the positive electrode sheet 111 and the negative electrode sheet 113 can be guaranteed, the short circuit between the positive electrode sheet 111 and the negative electrode sheet 113 is prevented, and the safety of operating the electrode assembly 100 of the secondary battery is improved. In addition, the waste of the material of the separator 112 can be avoided, which reduces the production cost of the electrode assembly 100 of the secondary battery.

When the electrode assembly 100 of the secondary battery is used to prepare a 280 Ah battery, the ratio of S1:D1 or S1:D2 is 0.615, and the ratio of S1:D3 or S1:D4 is 1.6. At this time, under the premise that the positive electrode sheet 111 and the negative electrode sheet 113 are not short-circuited, the safety of using and operating the 280 Ah battery is improved, and at the same time, the waste of the material of the separator 112 can be avoided, and the production cost of the 280 Ah battery can be reduced.

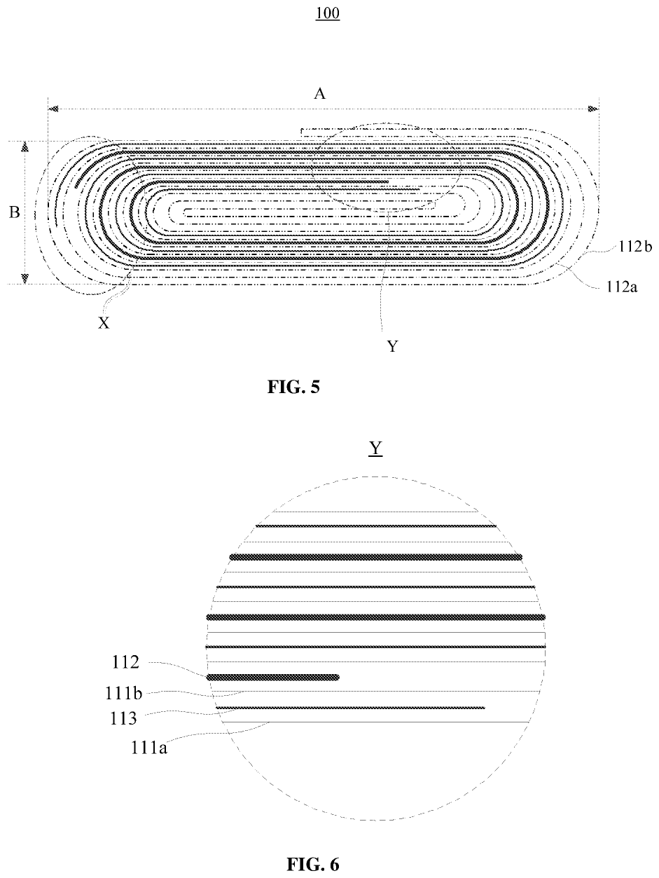

In some embodiments, as shown in FIG. 5, the length of the electrode assembly 110 of the secondary battery is A, 168 mm≤A≤172 mm, the thickness of the electrode assembly 110 of the secondary battery is B, 30 mm≤B≤33 mm, D1 and D2 are both 3 mm˜4 mm, D3 and D4 are both 1 mm˜2 mm.

When the length of the electrode assembly 110 of the secondary battery is smaller than 168 mm, and the thickness of the electrode assembly 110 of the secondary battery is smaller than 30 mm, the internal space of the casing 200 will be wasted, thereby reducing the energy density of the secondary battery 10. If it is desired to increase the energy density of the secondary battery 10, the size of the casing 200 needs to be redesigned correspondingly, which complicates the preparation of the casing 200. When the length of the electrode assembly 110 of the secondary battery is greater than 172 mm, and the thickness of the electrode assembly 110 of the secondary battery is greater than 33 mm, when the electrode assembly 110 of the secondary battery is installed in the casing 200, the electrode assembly 110 of the secondary battery is extremely easy to interfere with the internal structures of the casing 200, thereby reducing the safety of using and operating the secondary battery 10. Therefore, as overall considerations, the length of the electrode assembly 110 of the secondary battery is between 168 mm and 172 mm, and the thickness of the electrode assembly 110 of the secondary battery is between 30 mm and 33 mm, and thus when installing the electrode assembly 110 of the secondary battery into the casing 200, the waste of the internal space of the casing 200 can be avoided, thereby ensuring the energy density of the secondary battery 10, and the electrode assembly 110 of the secondary battery is prevented from interfering with the internal structures of the casing 200. Thus, the safety of the secondary battery 10 is ensured.

In the state where the length of the electrode assembly 110 of the secondary battery is A, 168 mm≤A≤172 mm, and the thickness of the electrode assembly 110 of the secondary battery is B, 30 mm≤B≤33 mm, when both D1 and D2 are smaller than 3 mm, that is, it means that the width of the first separator side edge area 1121 beyond the first negative pole side edge area 1131 and the width of the second separator side edge area 1122 beyond the second negative pole side edge area 1132 are relatively small. At this time, it is difficult to assure that the positive electrode sheet 111 and the negative electrode sheet 113 are insulated from each other. When both D1 and D2 are greater than 4 mm, the width of the first separator side edge area 1121 beyond the first negative pole side edge area 1131 and the width of the second separator side edge area 1122 beyond the second negative pole side edge area 1132 are relatively larger, thereby causing great waste of the separator 112, and increasing the production cost of the electrode assembly 100 of the secondary battery. Therefore, as overall considerations, D1 and D2 are both between 3 mm and 4 mm. In this way, not only the insulation between the positive electrode sheet 111 and the negative electrode sheet 113 can be ensured, and the short circuit between the positive electrode sheet 111 and the negative electrode sheet 113 can be prevented, and the safety of using and operating the electrode assembly 100 of the secondary battery is improved, but also it can also avoid waste of the material of the separator 112, thereby reducing the production cost of the electrode assembly 100 of the secondary battery.

When both D3 and D4 are smaller than 1 mm, the width of the first negative pole side edge area 1131 beyond the first positive pole side edge area 1111 and the width of the second negative pole side edge area 1132 beyond the second positive pole side edge area 1112 are relatively small. When the electrode assembly 100 of the secondary battery is charged, the part of the lithium ions detached from the positive pole active material layer 111b cannot be smoothly embedded into the negative pole active material layer 113b, so that a lithium precipitation phenomenon occurs. While the lithium precipitation phenomenon will form dendrites, which are likely to pierce the separator and cause a short circuit in the electrode assembly 100 of the secondary battery. When both D3 and D4 are greater than 1 mm, the width of the first negative pole side edge area 1131 beyond the first positive pole side edge area 1111 and the width of the second negative pole side edge area 1132 beyond the second positive pole side edge area 1112 are relatively large. Although the lithium precipitation phenomenon can be prevented, it will cause waste of the negative electrode sheet 113, thereby increasing the production cost of the electrode assembly 100 of the secondary battery. Therefore, as overall considerations, D3 and D4 are both between 1 mm and 2 mm, so that the lithium ions detached from the positive pole active material layer 111b can be smoothly embedded into the negative pole active material layer 113b when the electrode assembly 100 of the secondary battery is charged, which decreases the occurrence of lithium precipitation, and increases the safety of using and operating the electrode assembly 100 of the secondary battery, and at the same time, waste of the material of the negative electrode sheet 113 can be avoided, and the production cost of the electrode assembly 100 of the secondary battery can be reduced.

When the electrode assembly 100 of the secondary battery is used to prepare a 280 Ah battery, in a possible embodiment, both D1 and D2 are 3.25 mm, and both D3 and D4 are 1.25 mm.

Therefore, in the process of preparing the 280 Ah battery, when the electrode assembly 100 of the secondary battery is charged, the lithium ions detached from the positive pole active material layer 111b can be made to be smoothly embedded into the negative pole active material layer 113b, thereby preventing the occurrence of lithium precipitation and improving the safety of using and operating the electrode assembly 100 of the secondary battery. Meanwhile, the waste of the material of the negative electrode sheet 113 can be avoided, and the production cost of the electrode assembly 100 of the secondary battery can be reduced.

In some embodiments, along the width direction of the electrode assembly 100 of the secondary battery, the width of the insulating-material-coated area 111a2 is greater than or equal to 1.5 mm and smaller than or equal to 2.5 mm.

If the width of the insulating layer 111c is overly small, the burr portion of the insulating-material-coated area 111a2 cannot be completely covered, and there is still a risk that the burr pierces the separator 112 to cause a short circuit. On the contrary, if the width of the insulating layer 111c is overly large, the insulating area formed by the insulating layer 111c will extend beyond the insulating-material-coated area 111a2, thereby affecting the thickness of the positive electrode main body area 111x, which further affects the energy density of the electrode assembly 100 of the secondary battery. As overall considerations, when the width of the insulating-material-coated area 111a2 is larger than or equal to 1.5 mm and smaller than or equal to 2.5 mm, the energy density of the electrode assembly 100 of the secondary battery can also be guaranteed, on the premise that the burr portion of the insulating-material-coated area 111a2 is completely covered.

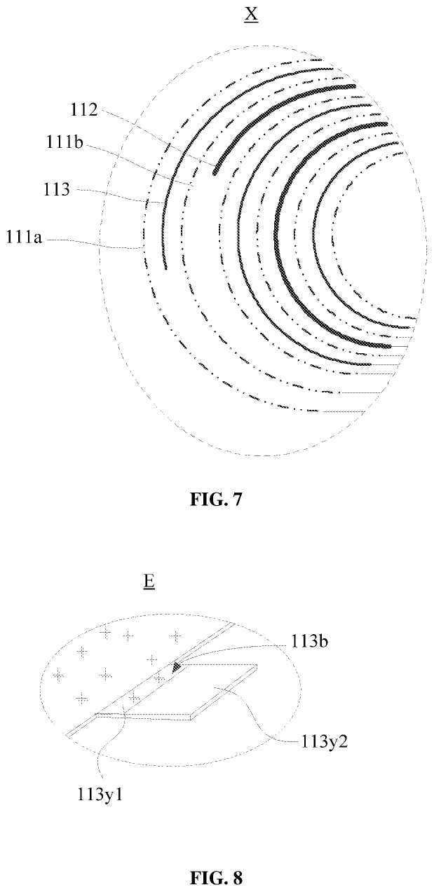

During the charging process of the electrode assembly 100 of the secondary battery, some of the lithium ions detached from the positive pole active material layer 111b cannot be smoothly embedded into the negative pole active material layer 113b, so that lithium ions can be precipitated only on the surface of the negative electrode sheet 113, that is, the phenomenon of lithium precipitation occurs. In order to prevent the phenomenon of lithium precipitation in the negative electrode sheet 113, in some embodiments, as shown in FIG. 5, FIG. 6 and FIG. 7, the separator 112 comprises a first separator 112a and a second separator 112a. The first separator 112a, the negative electrode sheet 113, the second separator 112b and the positive electrode sheet 111 are stacked in sequence and wound. The starting end of the negative electrode sheet 113 extends beyond the starting end of the positive electrode sheet 111, and the trailing end of the negative electrode sheet 113 extends beyond the trailing end of the positive electrode sheet 111.

In this way, the lithium ions detached from the positive electrode sheet 111 can be made to be smoothly embedded into the negative electrode sheet 113, which effectively reduces the occurrence of the lithium precipitation phenomenon.

In some embodiments, as shown in FIGS. 3 and 8, the negative pole tab area 113y comprises a negative pole tab root area 113y1 and a negative pole tab end area 113y2, and the negative pole tab root area is coated with a negative pole active material layer 113b.

The strength of the negative pole tab root area 113y1 can be improved by coating the negative pole active material layer 113b on the negative pole tab root area 113y1.

In some embodiments, the edge of the negative pole active material layer 113b on the negative pole main body area 113a1 extends beyond the edge of the insulating layer on the positive electrode main body area 111x along the direction of the negative pole main body area 113a1 pointing to the negative pole tab area 113y.

Therefore, the edge of the negative pole active material layer 113b on the negative pole main body area 113a1 extends beyond the edge of the insulating layer on the positive electrode main body area 111x, so that it can be guaranteed that the edge of the negative pole active material layer 113b on the negative pole main body area 113a1 extends beyond the edge of the positive pole active material layer 111b on the positive electrode main body area 111x, and therefore the lithium ions detached from the positive pole active material layer 111b can be smoothly embedded on the negative pole active material layer 113b, effectively avoiding the occurrence of lithium precipitation, and ensuring safety of the electrode assembly 100 of the secondary battery.

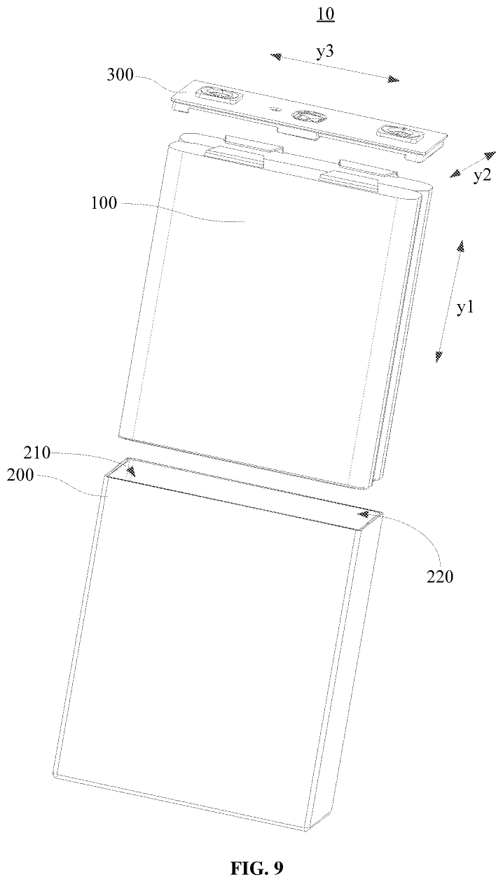

The present application also provides a secondary battery 10. As shown in FIG. 9, the secondary battery 10 comprises a casing 200, a top cover and the above-mentioned electrode assembly 100 of the secondary battery. The casing 200 is provided with an opening 210 on one side and an accommodating cavity 220 therein. The electrode assembly 100 of the secondary battery is located within the accommodating cavity 220; and the top cover sealingly covers the opening 210.

Since the secondary battery 10 in this embodiment adopts the electrode assembly 100 of the secondary battery described above, the electrode assembly 100 of the secondary battery can make the negative electrode sheet 113 and the positive electrode sheet 111 completely isolated from each other, thereby preventing the short circuit between the negative electrode sheet 113 and the positive electrode sheet 111, ensuring the safety of using and operating the electrode assembly 100 of the secondary battery. Therefore, this embodiment can improve the safety of using and operating the secondary battery 10.

It needs to be noted that the accommodating cavity 220 inside the casing 200, besides being used for accommodating the electrode assembly 100 of the secondary battery, also accommodates the electrolyte, so that the electrode assembly 100 of the secondary battery accommodated in the accommodating cavity 220 can be in contact with the electrolyte, so as to realize the charging of the secondary battery 10.

When the electrode assembly 100 of the secondary battery is installed into the accommodating cavity 220 of the casing 200, the electrode assembly 100 of the secondary battery is accommodated in the accommodating cavity 220 through the opening 210 of the casing 200. In addition, plurality of electrode assemblies 100 of a secondary battery can be installed in the accommodating cavity 220. When the plurality of electrode assemblies 100 of a secondary battery are installed into the accommodating cavity 220, the electrode assemblies 100 of a secondary battery are first stacked outside the casing 200 so as to make two adjacent electrode assemblies 100 of a secondary battery electrically connected with each other, and then the plurality of electrode assemblies 100 of a secondary battery, which are the stacked and electrically connected, are installed into the accommodating cavity 220 through the opening 210, so that the electrode assemblies 100 of the secondary battery can be placed into the accommodating cavity 220 of the casing 200 through the opening 210.

It should be noted that the casing 200 may be hexahedral or of other shapes. The material of the casing 200 may be a metal material (such as, aluminum or aluminum alloy, etc.) or an insulating material (such as, plastic, etc.).

The secondary battery 10 is also called as a rechargeable battery or a storage battery, and refers to a secondary battery 10 that can be used continuously by activating an active material by means of charging, after the secondary battery 10 is discharged.

It should also be noted that the secondary battery 10 has a length direction (that is, the direction indicated by the arrow y3 in FIG. 9), the width direction (that is, the direction indicated by the arrow y2 in FIG. 9), and the height direction (that is, the direction indicated by the arrow y1 in FIG. 9). The length direction of the secondary battery 10 is the same as the length direction of the electrode assembly 100 of the secondary battery, the width direction of the secondary battery 10 is the same as the thickness direction of the electrode assembly 100 of the secondary battery, and the height direction of the secondary battery 10 is the same as the width direction of the electrode assembly 100 of the secondary battery.

Finally, it should be noted that the above embodiments are only used to illustrate the technical solutions of the present application, but not to limit them. Although the present application has been described in detail with reference to the foregoing embodiments, those skilled in the art should understand that it is still possible to modify the technical solutions recorded in the foregoing embodiments, or perform equivalent replacements on some or all of the technical features. These modifications or replacements do not make the essence of the corresponding technical solutions deviate from the scope of technical solutions of embodiments of the present application.

What is claimed is:

1. An electrode assembly of a secondary battery comprising:
a positive electrode sheet, a separator and a negative electrode sheet, wherein the positive electrode sheet, the separator and the negative electrode sheet are stacked in sequence and wound,
wherein:
the positive electrode sheet comprises a positive electrode main body area and a positive electrode tab area, and at least one surface of the positive electrode main body area is coated with a positive pole active material layer;
the negative electrode sheet comprises a negative pole main body area and a negative pole tab area, at least one surface of the negative pole main body area is coated with a negative electrode active material layer;
the separator is sandwiched between the positive pole active material layer and the negative pole active material layer; and
along a width direction of the electrode assembly of the secondary battery, edges on both sides of the separator extend beyond edges on both sides of the negative pole main body area, and edges on both sides of the negative pole main body area extend beyond edges on both sides of the positive electrode main body area.

2. The electrode assembly of a secondary battery according to claim 1, wherein:
the positive electrode main body area has a first positive pole side edge area and a second positive pole side edge area opposite to each other;
the separator has a first separator side edge area and a second separator side edge area opposite to each other;
the negative pole main body area has a first negative pole side edge area and a second negative pole side edge area opposite to each other;
along the width direction of the electrode assembly of the secondary battery, a distance by which an edge of the first separator side edge area extends beyond an edge of the first negative pole side edge area is D1, and a distance by which an edge of the second separator side edge area extends beyond an edge of the second negative pole side edge area is D2, wherein D1=D2; and
a distance by which an edge of the first negative pole side edge area extends beyond an edge of the first positive pole side edge area is D3, and a distance by which an edge of the second negative pole side edge area extends beyond an edge of the second positive pole side edge area is D4, wherein D3=D4.

3. The electrode assembly of a secondary battery according to claim 2, wherein:
the positive electrode main body area comprises a positive-pole-active-material-coated area and an insulating-material-coated area, the insulating-material-coated area is located between the positive-pole-active-material-coated area and the positive pole tab area, and the positive pole active material layer is coated on the positive-pole-active-material-coated area; and
the positive pole tab area comprises a positive pole tab root area and a positive pole tab end area, the insulating-material-coated area and the positive pole tab root area are both coated with an insulating layer, and a width of the positive pole tab root area is greater than a width of the insulating-material-coated area along a width direction of the electrode assembly of the secondary battery, and an edge of the positive pole active material layer on the positive electrode main body area overlaps an edge of the insulating layer.

4. The electrode assembly of the secondary battery according to claim 3, wherein along the width direction of the electrode assembly of the secondary battery, the width of the insulating-material-coated area is S1, wherein value of S1:D1 or S1:D2 is 0.6˜0.7, and value of S1:D3 or S1:D4 is 2˜3.

5. The electrode assembly of a secondary battery according to claim 4, wherein value of S1:D1 or S1:D2 is 0.615, and value of S1:D3 or S1:D4 is 2.6.

6. The electrode assembly of the secondary battery according to claim 5, wherein:
a length of the electrode assembly of the secondary battery is A, wherein 168 mm≤A≤172 mm, and a thickness of the electrode assembly of the secondary battery is B, wherein 30 mm≤B≤33 mm; and
both D1 and D2 are 3 mm˜4 mm, and both D3 and D4 are 1 mm˜2 mm.

7. The electrode assembly of a secondary battery according to claim 5, wherein the width of the insulating-material-coated area is greater than or equal to 1.5 mm, and smaller than or equal to 2.5 mm, along the width direction of the electrode assembly of the secondary battery.

8. The electrode assembly of a secondary battery according to claim 3, wherein the negative pole tab area comprises a negative pole tab root area and a negative pole tab end area, and the negative pole tab root area is coated with the negative pole active material layer.

9. The electrode assembly of a secondary battery according to claim 8, wherein along a direction from the negative pole main body area to the negative pole tab area, an edge of the negative pole active material layer on the negative electrode sheet extends beyond an edge of the insulating layer on the positive electrode main body area.

10. A secondary battery comprising:
a casing, wherein the casing comprises an opening at one side of the casing and an accommodating cavity in the casing;
the electrode assembly of the secondary battery according to claim 1, wherein the electrode assembly of the secondary battery is accommodated in the accommodating cavity; and
a cover hermetically covering the opening.
